(19) United States
(12) Patent Application Publication
(10) Pub. No.: US 2025/0092724 A1
(43) Pub. Date: Mar. 20, 2025

(54) DOOR HOLDING SYSTEMS AND DEVICES

(71) Applicant: Chris Leitschuh, Andover, MN (US)

(72) Inventor: Chris Leitschuh, Andover, MN (US)

(21) Appl. No.: 18/825,448

(22) Filed: Sep. 5, 2024

Related U.S. Application Data
(60) Provisional application No. 63/539,431, filed on Sep. 20, 2023.

(51) Int. Cl. E05C 17/54

(52) U.S. Cl. CPC E05C 17/54

(57) ABSTRACT

A door holding device for holding a door in an opened position. The door holding device includes a flexible line, a retention body, and a catch member. The flexible line defines opposing, first and second ends and is connected to the retention body so as to form an adjustable loop. The catch member is secured to the flexible line at the second end. The loop is initially sized for placement about the door's handle (or other surface), and then cinched. With the door in a desired opened position, the catch member is available for temporary connection to a support structure apart from the door. Once connected, the holding device maintains or holds the door in the opened position, with tension in the flexible line preventing the door from moving to or toward the closed position.

### CROSS-REFERENCE TO RELATED APPLICATIONS

This U.S. patent application claims the benefit of the filing date of U.S. Provisional Patent Application No. 63/539,431, filed Sep. 20, 2023, the entire teachings of which are incorporated herein by reference.

### BACKGROUND

The present disclosure is directed to systems and devices for holding doors. More particularly, it relates to portable devices useful for holding open most vertically-hung doors to a desired extent regardless of the door's construction.

Virtually every building and home has at least one door assembly. Door assemblies generally consist of a door attached to a frame by hinges. The door pivots about a vertical axis defined by the hinges, moving between opened and closed positions. A latch mechanism is typically carried by the door that secures or holds the door relative to the frame in the closed position. A handle carried by the door is operable by the user to disconnect the latch mechanism when in the closed state, and provides a convenient grasping surface for moving the door between the closed and opened positions.

Virtually all door assemblies readily retain the door in the closed position (e.g., the latch mechanism). However, many constructions do not allow the door to self-maintain or hold a selected opened position. In the presence of an external force (e.g., wind) and/or due to the weight of the door itself, the door will move from a desired opened position to the closed position. This can be exceedingly frustrating for a user who desires for the door to stay open while s/he traverses back-and-forth through the door opening. Oftentimes, a user will attempt to maintain the door in a selected opened position by inserting a wedge-type door stop or similar object under the door and/or within a gap between an inside edge of the door and the frame. While potentially viable, these and similar techniques are less then optimal. Door stops are easily lost and can be difficult to install. Further, once installed, the door stop or similar object is prone to dislodgement or sliding along the floor, and may not consistently maintain the door at the particular opened position desired by the user.

### BRIEF DESCRIPTION OF THE DRAWINGS

FIG. 1 is a side perspective view of a door holding device in accordance with principles of the present disclosure;

FIG. 2A is a simplified top view of an environment with which the door holding devices and systems of the present disclosure are useful, including a door assembly with a door in a closed position;

FIG. 2B is the top view of the environment of FIG. 2A, with the door in an opened position;

FIGS. 3A and 3B are simplified top views illustrating use of a door holding device of the present disclosure to hold the door in the opened position;

FIGS. 4A and 4B are simplified top views illustrating use of a door holding system of the present disclosure to hold the door in the opened position;

FIGS. 5-7C illustrate installation of the door holding device of FIG. 1 to a door knob; and

FIGS. 8A and 8B illustrate the door holding device of FIG. 1 holding a door.

### DETAILED DESCRIPTION

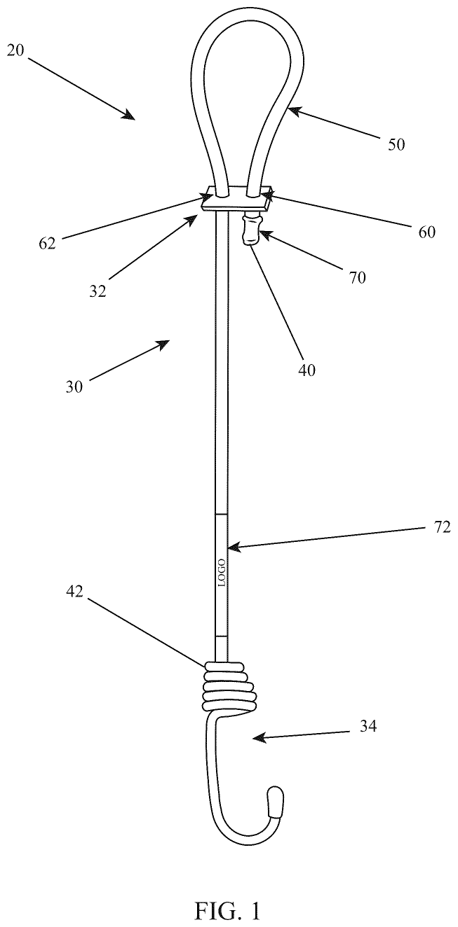

One embodiment of a door holding device 20 in accordance with principles of the present disclosure is shown in FIG. 1. The door holding device 20 includes a flexible line 30, a retention body 32 and a catch member 34. Details on the various components are provided below. In general terms, the flexible line 30 defines opposing, first and second ends 40, 42. The flexible line 30 is connected to the retention body 32 so as to form a loop 50 near the first end 40. A size of the loop 50 can be adjusted by applying a force to slide a segment of the flexible line 30 relative to the retention body 32 (or vice-versa). The catch member 34 is secured to the flexible line 30 at the second end 42. During use, a user selects a desired size of the loop 50 for placement about an available structure or surface of the door to be held open (e.g., the door's handle). A size of the loop 50 can then be lessened, effectively cinching the flexible line 30 onto or about the door structure. With the door in a desired opened position, the catch member 34 is available for temporary connection to a support structure apart from the door. Once connected, the holding device 20 maintains or holds the door in the opened position, with tension in the flexible line 30 preventing the door from moving to or toward the closed position.

The flexible line 30 can assume a variety of forms appropriate for cinching about a door handle or other structure while exhibiting sufficient tensile strength to maintain its structural integrity under expected tension forces. In some embodiments, the flexible line 30 can be or include a shock cord (or a bungee cord) or the like with an elastic (e.g., rubber) core and an outer cover or sheath (e.g., woven or braided cotton, polypropylene, polyester, nylon, etc.). For example, the flexible line 30 can be a 3/16 inch diameter shock cord. Other formats for the flexible line 30 can be employed, such as rope, belt, cable, chain, wire, etc. As described in greater detail below, in some embodiments, the flexible line 30 is constructed such that an exterior surface thereof is conducive to a high frictional interface with the retention body 32. With these and related embodiments, the exterior surface of the flexible line 30 can have a variety of colors. In some examples, a color of the exterior surface is selected to be highly distinctive so that the door holding device 20 can more easily be located or identified by a user. For example, the exterior surface can be a neon color, such as neon green, neon orange, etc. Other colors, or combination of colors, are also acceptable.

The retention body 32 is generally configured to interface with the flexible line 30 at a first location 60 and a second location 62, dictating that the loop 50 is formed by the flexible line 30. In some embodiments, in some embodiments, a slidable interface is provided at the first location 60, and a more permanent connection is provided at the second location 62. The retention body 32 is formed (e.g., casted, machined, etc.) from a lightweight, structurally robust material, such as hardened plastic (e.g., high-density polyethylene), and has a size and shape conducive to handling by a user's fingers.

In some embodiments, the slidable interface between the retention body 32 and the flexible line 30 at the first location 60 is provided by defining the first location 60 as hole formed through a thickness of the retention body 32. The first location hole 60 is sized and shaped to slidably receive the flexible line 30. In some examples, a size (e.g., diameter) of the first location hole 60 is commensurate with or approximates an outer dimension (e.g., outer diameter) of the flexible line 30, and the retention body 32 is formed of a material exhibiting a heightened frictional interface with an exterior of the flexible line 30. With this but one acceptable construction, the flexible line 30 is frictionally engaged with the retention body 32 along the first location hole 60 in a relatively tight fit; although the flexible line 30 is able to move or slide relative to the retention body 32 along the first location hole 60 (and vice-versa), it moves only through the application of force (e.g., pulling or pushing the flexible line 30 relative to the retention body 32 (and/or vice-versa)). In the absence of an applied force, it is expected that the flexible line 30 will not move along or within the first location hole 60.

A more robust interface between the retention body 32 and the flexible line 30 at the second location 62 (as compared to the slidable relationship provided at the first location 60) can be accomplished in a variety of manners. In some non-limiting examples, the second location 62 can be defined by a hole formed through a thickness of the retention body 32, sized to receive the flexible line 30. After inserting the first end 40 of the flexible line 30 through the second location hole 62 and beyond the retention body 32, a fixation member 70 can be assembled onto or over the flexible line 30 proximate the first end 40. The fixation member 70 can assume various forms (e.g., an elastic sleeve). Regardless, upon final assembly, a resultant outer diameter of the fixation member 70 is greater than a diameter of the second location hole 62, thus preventing the first end 40 from being pulled back through the second location hole 62. That is to say, while the flexible line 30 may be able to slide relative to the retention body 32 at or within the second location hole 62, the fixation member 70 prevents the first end 40 from sliding into or through the second location hole 62 such that the first end 40 is effectively fixed relative to the retention body 32.

A number of techniques can be employed to create an enlarged diameter proximate the first end 40 following insertion through the second location hole 62. For example, after insertion, a sleeve (e.g., metal sleeve) can be crimped over or onto the first end 40. In some optional embodiments, following crimping, the metal sleeve can be covered with shrink tubing or similar material for aesthetic purposes. Alternatively, after insertion, the first end 40 can be folded or looped back onto the flexible line 30 and crimped in place with a hog ring (or similar device). In some optional embodiments, an auxiliary implement can be captured within the so-formed loop, such as split ring. Where provided, the split ring can be available for attachment of a variety of items, for example a tag displaying words, characters, designs, etc., of interest. In other embodiments, the split ring (or other auxiliary implement) can be omitted. In yet other embodiments, after insertion through the second location hole 62, the first end 40 can be subject to heat, causing the material of the flexible line 30 to melt and, once cooled, assume a larger outer dimension that is greater than a diameter of the second location hole 62. In yet other embodiments, the first end 40 can be attached directly onto the retention body 32 at the second location 62 (e.g., weld, adhesive, bond, etc.); with these and related embodiments, a hole need not necessarily be formed through a thickness of the retention body 32 at the second location 62.

The catch member 34 can assume a variety of forms useful for engaging a separate structure. In some embodiments, the catch member 34 can have a simplified format, conducive to easy, straightforward use such as the hook construction shown in the views. With these and related embodiments, the hook 34 can be quickly connected to, and removed from, a plethora of different structures, for example the eyelet of a separately-provided eyebolt or eye screw (or similar device), a surface protrusion, etc. Alternatively, the catch member 34 can assume or formats that may or may not include a hook (e.g., ring, clasp, clip, buckle, magnet, etc.). Regardless, the catch member 34 can be secured to the second end 42 of the flexible line 30 in various fashions. For example, where the flexible line 30 is a shock cord and the catch member 34 is a hook (or similar device), the catch member 34 can be installed to the second end 42 of the flexible line 30 using a hog ring in accord with conventional techniques.

The door holding device 20 can optionally include one or more additional features. For example, an identifier can be displayed along a length of the flexible line 30. With these and related embodiments, a display body 72 (e.g., shrink tubing) can be assembled over the flexible line 30. Prior to assembly, desired indicia (e.g., words, characters, designs, etc., of interest) can be formed (e.g., printed) onto the display body 72. In other embodiments, the display body 72 can be omitted.

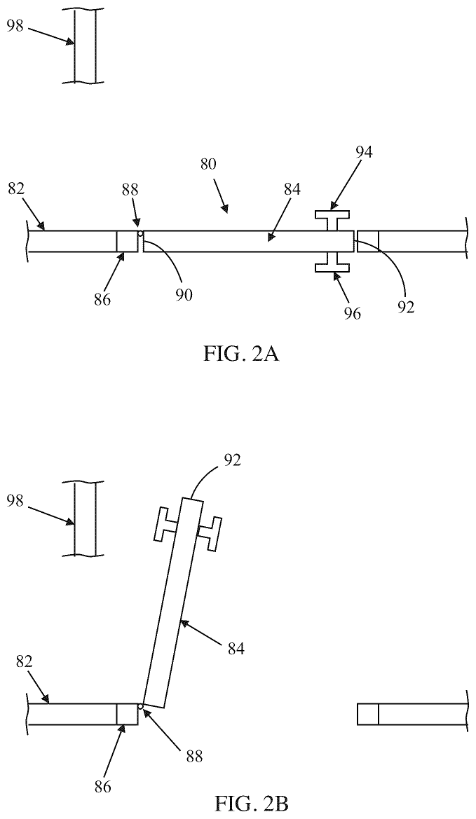

The door holding device 20 is easily installed and arranged to hold a door open as described in greater detail below. As a point of reference, an environment in which the systems and devices are useful is shown in simplified form in FIGS. 2A and 2B that reflect a conventional door assembly 80 installed in a wall or similar structure 82. The door assembly 80 includes a door 84 mounted to a door frame 86 by hinge mechanisms 88. With this construction, the door 84 defines a hinged or connected side 90 opposite a free side 92. The door 84 carries interior and exterior handles 94, 96 near the free side 92 (e.g., the handles 94, 96 can be parts of a conventional latch mechanism). FIG. 2A illustrates the door 84 in a closed position; the door 84 can be transitioned to the opened position of FIG. 2B by pivoting the door 84 relative to the frame 86 via the hinge mechanisms 88. In many homes or buildings, a separate structure 98 (e.g., a wall, a frame, a stand or other object) will be in place or otherwise previously exists apart from the door 84 and nearby the free side 92 in the opened position.

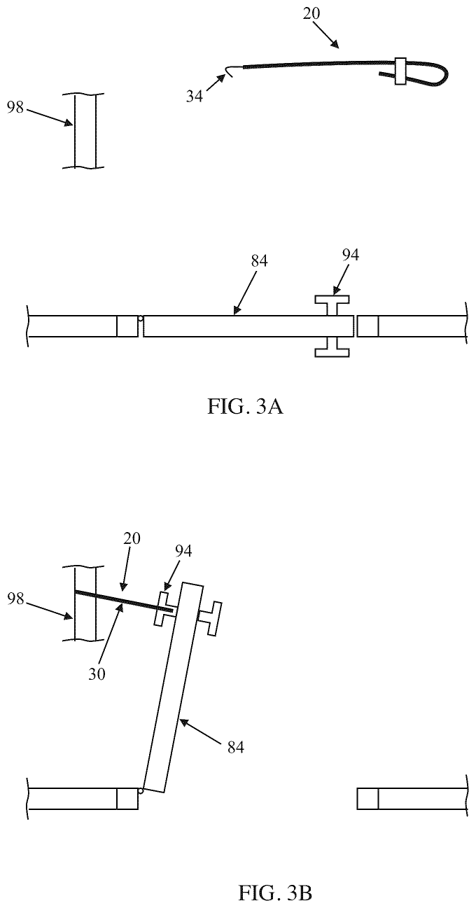

With the above in mind, FIGS. 3A and 3B illustrate, in simplified form, use of the door holding device 20 to hold the door 84 in the opened position. In the state of FIG. 3A, the door holding device 20 is available for use, but has not yet been installed to the door 84. Installation of the door holding device 20 is described in greater detail below, and can be performed with the door 84 in the closed position of FIG. 3A or in an opened position. Regardless, once installed to the door 84 (e.g., at the interior handle 94) and with the door 84 in the desired opened position, the door holding device 20 is connected to or engaged with the separate structure 98 via the catch member 34. Upon final installation, the door holding device 20 connects the door 84 and the separate structure 98, with tension in the flexible line 30 maintaining the door 84 in the opened position.

Connection or engagement between the catch member 34 and the separate structure 98 can be accomplished in various fashions. In some examples, the separate structure 98 will have a surface feature or other attribute conducive to receiving or capturing the catch member 34 (hidden in FIG. 3B). For example, the separate structure 98 can have naturally-occurring ridges or protrusions that readily engage with the catch member 34. Alternatively, an engagement device (e.g., eye screw) adapted to interface with the catch member 34 can previously have been installed to the separate structure. In yet other embodiments, the separate structure 98 can be an upright board, pole, stand or the like; the flexible line 30 can be wound about the upright and the catch member 34 then engaged onto the flexible line 30 itself.

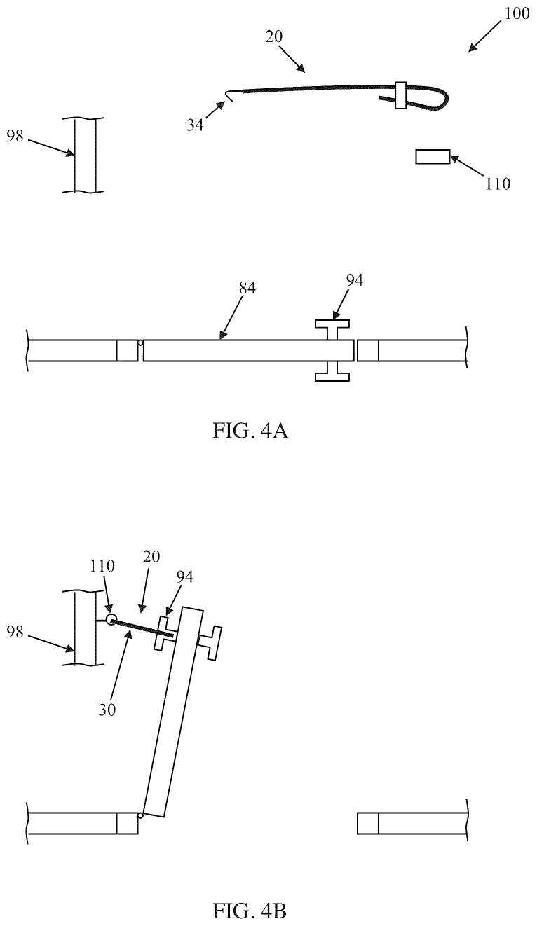

In yet other end-use applications, the separate structure 98 may not present an appropriate surface or other feature for engagement by the catch member 34. With this in mind, FIGS. 4A and 4B illustrate, in simplified form, a door holding system 100 in accordance with principles of the present disclosure. The door holding system 100 includes the door holding device 20 as described above, along with a capture device 110 (shown in block form in FIG. 4A). The capture device 110 is generally configured for assembly to the separate structure 98 and provides one or more features appropriate for engaging the catch member 34. In some examples, the capture device 110 is configured for more permanent assembly to the separate structure 98 (e.g., the capture device 110 can be configured for mounting to the separate structure 98 via screw(s) and/or nails, such as an eye screw, a nail-in hook, etc.). In other embodiments, the capture device 110 is configured for non-destructive mounting the separate structure 98 (e.g., a hook or ring-type member secured to a wall of the separate structure 98 by a stretch release-type backing). Regardless, and with reference to FIG. 4B, the capture device 110 is installed to the separate structure 98 at a location proximate an expected location of the free side 92 of the door 84 in the opened position. The door holding device 20 is installed to the door 84 (e.g., at the interior handle 94) and with the door 84 in the desired opened position, the door holding device 20 is connected to or engaged with the capture device 110 via the catch member 34. Upon final installation, the door holding device 20 connects the door 84 and the separate structure 98 (via the capture device 110), with tension in the flexible line 30 maintaining the door 84 in the opened position. Once the user no longer desires to have the door 84 held in the open position, the door holding device 20 can be removed. The capture device 110 can be left in place with the separate structure 98, available for subsequent use. Alternatively, where the capture device 110 has a more temporary or removable format, the capture device 110 can be removed from the separate structure 98.

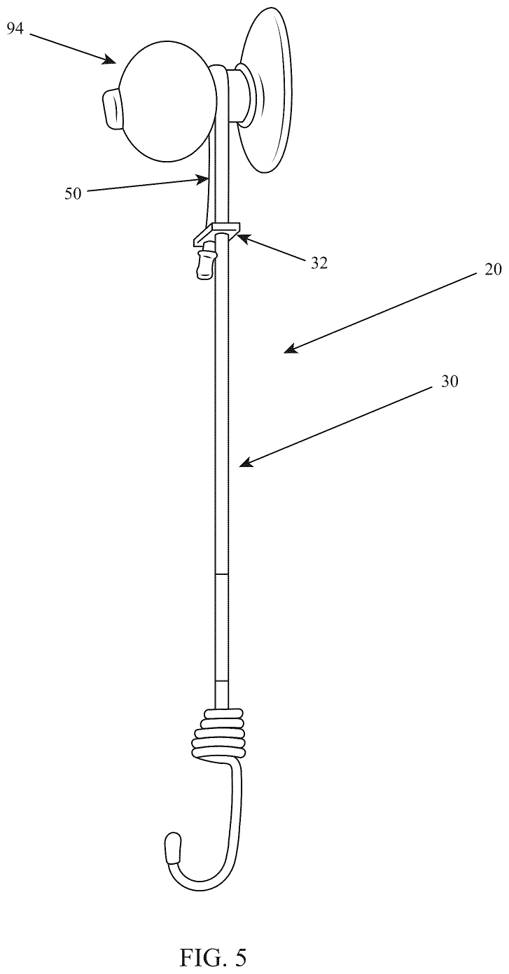

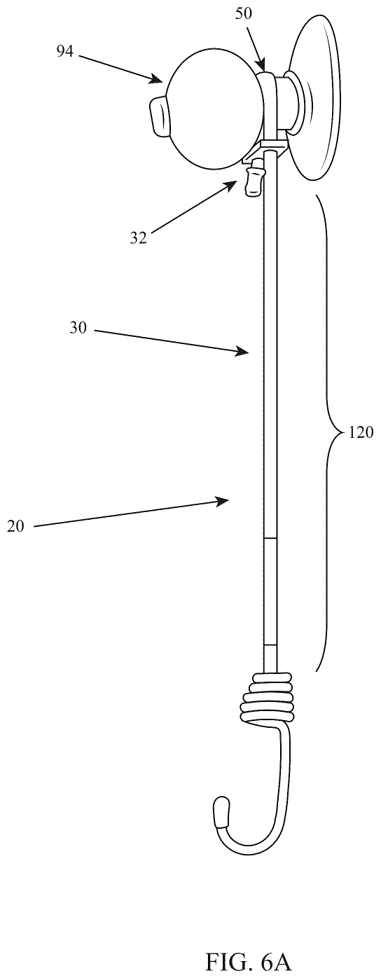

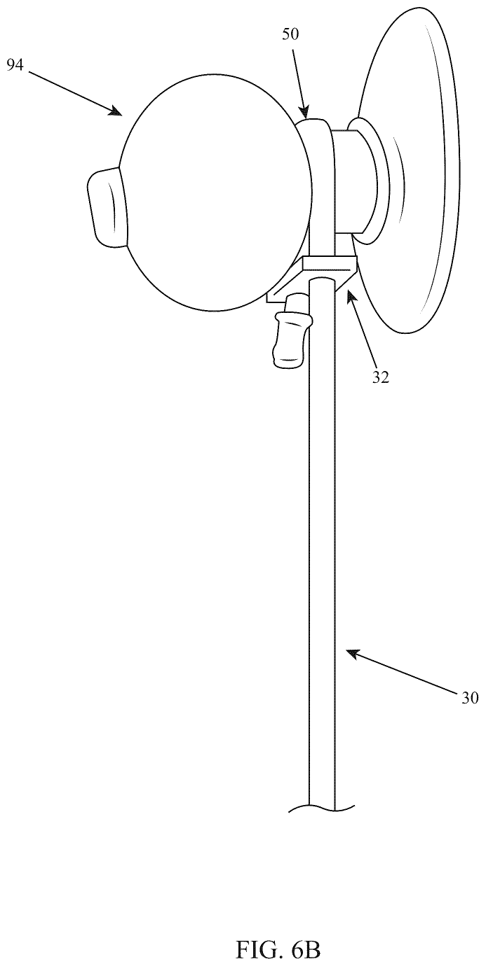

Regardless of whether the capture device 110 is needed, the door holding device 20 can be assembled to the door 84 in a variety of fashions. One non-limiting example of methods of the present disclosure begins with FIG. 5. The flexible line 30 is slidably manipulated relative to the retention body 32 (and/or vice-versa) to from the loop 50 to be of sufficient size for placement over or about a surface on the door 84, for example the handle 94. Once placed over the interior handle 94 (or other surface), the flexible line 30 is slidably manipulated relative to the retention body 32 so as to shorten a size of the loop 50, with the loop 50 cinching over or about the handle 94 as in FIGS. 6A and 6B.

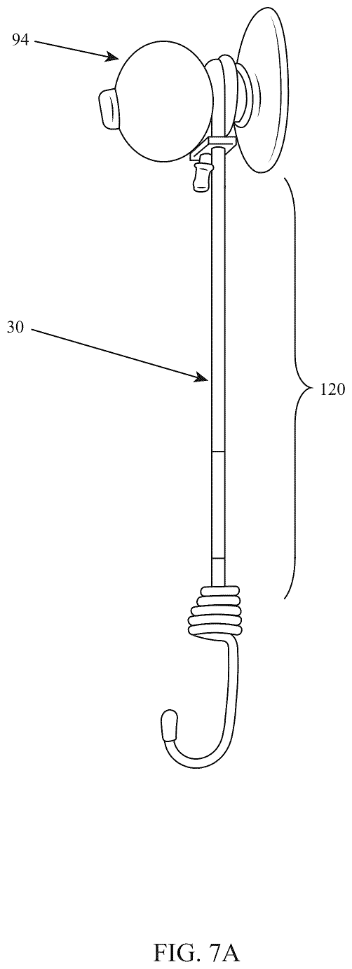

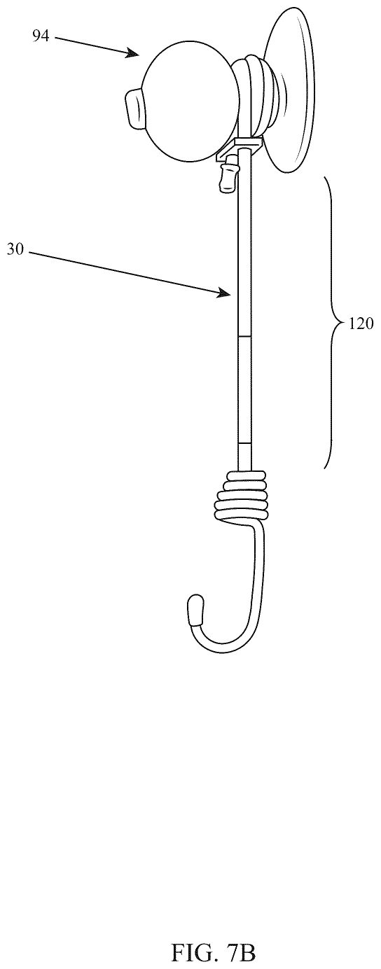

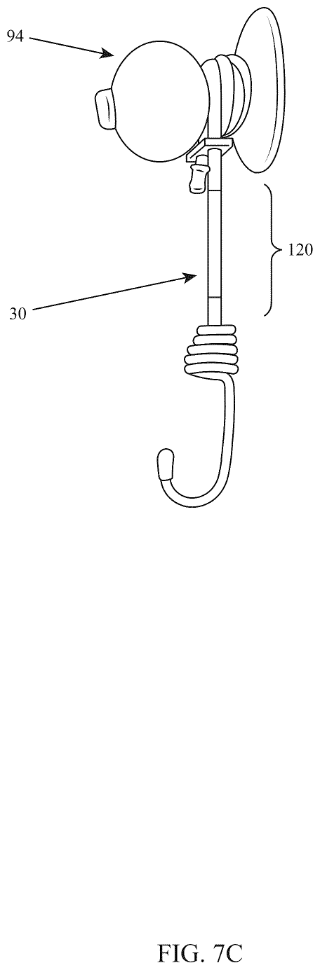

In the cinched state of FIG. 6A, a section 120 of the flexible line 34 freely extends from the handle 94 to the catch member 34. It will be understood that a length of the free section 120 effectively dictates the arrangement of the door 84 (FIG. 2A) in the opened position once the catch member 34 is secured to the separate structure. The shorter a length of the free section 120, the closer the free side 92 (hidden in FIG. 6A, but shown, for example, in FIG. 2A) of the door 84 will be maintained relative to the separate structure (and thus the opening through the doorway will be greater). With this in mind, a user desiring to shorten a length of the free section 120 can wind the flexible line 30 about the handle 94 to achieve a desire length. FIGS. 7A-7C illustrate various manners in which the door holding device 20 can be installed to a structure of the door 84 (e.g., the interior handle 94) at differing lengths of the free section 120.

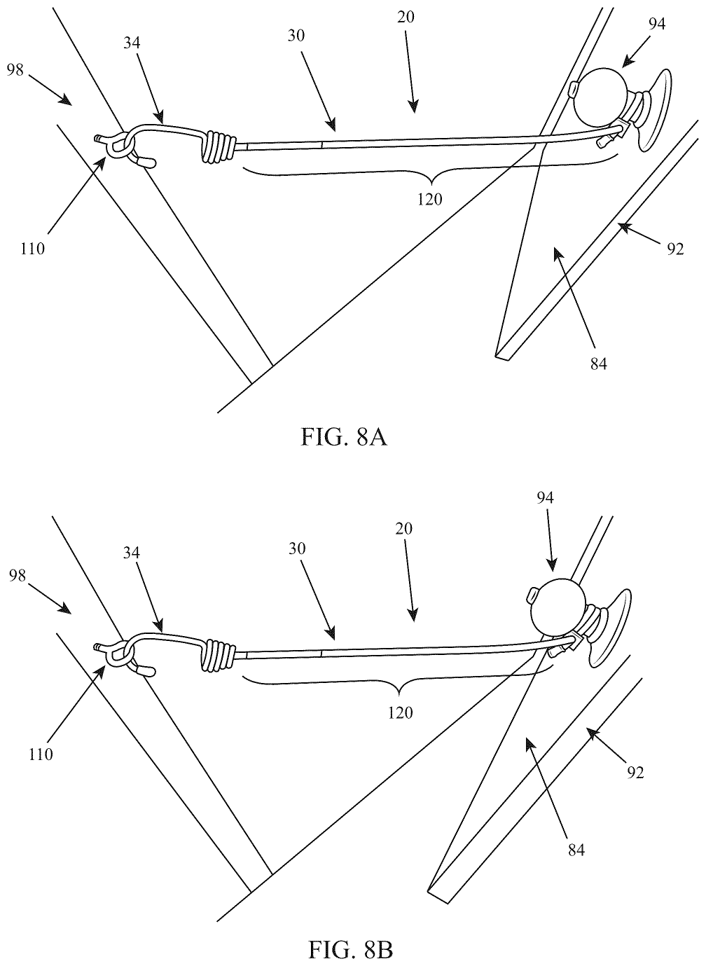

With the door holding device 20 installed to the door 84, the catch member 34 is then connected or engaged to the separate structure 98 as shown in FIGS. 8A and 8B. With the non-limiting examples of FIGS. 8A and 8B, a capture device 110 (an eye screw) has been installed to the separate structure 98, and the catch member 34 engaged to the capture device 110. Tension in the flexible line 30 maintains the door 84 in the opened position of FIGS. 8A and 8B. As a point of reference, FIGS. 8A and 8B further illustrate different opened positions. In the arrangement of FIG. 8A, the flexible line 30 has not been wound about the handle 94; in the arrangement of FIG. 8B, the flexible line 30 has been wound once around the handle 94. Thus, a length of the free section 120 is greater in the arrangement of FIG. 8A as compared to the arrangement of FIG. 8B. As a result, the free side 92 of the door 84 is further away from the separate structure 98 in the arrangement of FIG. 8A as compared to the arrangement of FIG. 8B.

Although the present disclosure has been described with reference to preferred embodiments, workers skilled in the art will recognize that changes can be made in form and detail without departing from the spirit and scope of the present disclosure.

What is claimed is:

1. A door holding device comprising:
a flexible line extending from a first end to a second end;
a retention body connected to the flexible body such that the flexible body forms an adjustable loop proximate the first end; and
a catch member secured to the second end.

2. The door holding device of claim 1, wherein the door holding device is configured such that the loop can be cinched about a surface of door to be held open, and the catch member is configured to engage a separate structure apart from the door.

3. The door holding device of claim 2, wherein the door holding device is configured such that upon final installation, tension in the flexible line maintains the door in an opened position.

4. The door holding device of claim 1, wherein the flexible line is a shock cord.

5. The door holding device of claim 1, wherein the flexible line is connected to the retention body at first and second locations.

6. The door holding device of claim 5, wherein the retention body is configured such that the flexible line is slidable relative to the retention body relative to at least one of the first and second locations.

7. The door holding device of claim 6, wherein the retention body defines a first hole at the first location for slidably receiving the flexible line.

8. The door holding device of claim 7, wherein the retention body defines a second hole at the second location for receiving the flexible line.

9. The door holding device of claim 8, further comprising a fixation member formed proximate the first end of the flexible line, wherein an outer dimension of the fixation member is greater than a diameter of the second hole.

10. The door holding device of claim 1, wherein the catch member includes a hook.

11. A method of holding open a door, the method comprising:
providing a door holding device including:
a flexible line extending from a first end to a second end,
a retention body connected to the flexible body such that the flexible body forms an adjustable loop proximate the first end,
a catch member secured to the second end;
forming the adjustable loop to a first size;
assembling the adjustable loop in the first size over a surface of a door;
forming the adjustable loop to a second size that is less than the first size such the adjustable loop is cinched about the surface;
maneuvering the door to an opened position; and
connecting the catch member relative to a structure apart from the door;
wherein following connection of the catch member to the structure, tension in the flexible line maintains the door in the opened position.

12. The method of claim 11, wherein the surface of the door is a door handle.

13. The method of claim 11, wherein following the step of maneuvering the door to the opened position, the method further comprising:
winding a section of the flexible line about the surface to reduce a length of a free section of the flexible line that otherwise extends from the surface.

14. The method of claim 11, further comprising:
mounting a capture device to the structure apart from the door;
wherein the step of connecting the catch member includes securing the catch member to the capture device.

15. The method of claim 14, wherein the capture device defines an eyelet for receiving the catch member.
